(19) United States
(12) Patent Application Publication
(10) Pub. No.: US 2006/0007938 A1
(43) Pub. Date: Jan. 12, 2006

(54) Telephone number information system for internet protocol telephony

(76) Inventors: Shouichi Kimura, Yokohama (JP); Kazutoshi Kobayashi, Yokohama (JP); Jun Ito, Yokohama (JP); Hiroyuki Kida, Yokohama (JP); Tatsuya Fukuyo, Yokohama (JP); Sachito Shibata, Yokohama (JP); Koichiro Hojyo, Yokohama (JP); Naomi Ojima, Yokohama (JP); Michiko Osawa, Yokohama (JP); Akira Yonenaga, Yokohama (JP); Hirotomo Yasuoka, Yokohama (JP); Takashi Ueno, Yokohama (JP)

Correspondence Address: KATTEN MUCHIN ROSENMAN LLP, 575 MADISON AVENUE, NEW YORK, NY, 10022-2585, US

(21) Appl. No.: 11/007,809

(22) Filed: Dec. 8, 2004

(30) Foreign Application Priority Data
Jul. 12, 2004 (JP) 2004-204604

(51) Int. Cl. H04L 12/66

(52) U.S. Cl. 370/395.52; 370/352

(57) ABSTRACT

Internet Protocol (IP) telephone number information system performs for the telephone number in the existing communication systems. A number information server in the system has a region information database representing an IP telephony service area for each of a plurality of Internet Service Providers (ISPs) having a corporate information database. The number information server specifies one of the plurality of ISPs from the region information database, based on a search condition input from a user terminal connected to the Internet. The specified ISP searches the corresponding corporate information database, and obtains number information matching the search condition. The number information server notifies the user terminal of the number information obtained from searching the corporate information database, in response to the search condition input from the user terminal.

### BACKGROUND OF THE INVENTION

1. Field of the Invention

The present invention relates to a method for providing a telephone number information service in Internet Protocol telephone service (IP telephony), and more particularly a method for providing a telephone number information service in IP telephony enabling corporate information search for each region on which the corporation is based, such as telephone number of a corporation contracting with an Internet Service Provider (ISP: a service provider providing a connection service to the Internet) which provides ‘Voice over Internet Protocol’ (VoIP: a voice communication service using a telephone number with a particular prefix such as ‘050’, using the Internet as communication infrastructure, which is referred to as IP telephony).

2. Description of the Related Art

With wide spread of the Internet, use of low cost IP telephony is becoming popular. In particular, to obtain subscribers, Internet Service Providers (ISPs) take into view the provision of IP telephony services.

In case of portable telephone mainly owned personally, a telephone number information service is not particularly necessary. However, in case of IP telephony, particularly when a corporate body obtains an IP telephone number, it becomes necessary for the corporate body to make the obtained telephone number known to others through the telephone number information service, because the way of use is near to a fixed telephone service.

In case of a fixed network, implementation of the information service is easy, because the telephone service is mostly provided by a restricted number of authorized telephone service providers. Since such telephone service providers own nationwide information, when searching a telephone number, it becomes necessary for the users to begin the search with specifying the region of the target.

The methods for installing such a service are shown in FIGS. 1, 2. A typical system is disclosed in the official gazette of the Japanese Unexamined Patent Publication No. 2003-125084, as shown in FIG. 1. In this system, a number information service user 2 receives telephone number information from an information database 12 through the Internet 3, using a Web browser 20. Information database 12 includes corporate telephone numbers, etc. open to public, and is installed in a Web server 1 to provide the telephone number information service. Number information service user 2 sends a request for telephone number information by accessing Web content 10 provided for number information. Web server 1 searches database 12 using a search engine 11, and displays the search result on Web browser 20. Thus, the number information service user can receive the desired telephone number.

FIG. 2 shows an example of utilizing a telephone number information system provided in a telephone office 1₁. Telephone office 1₁ provides a telephone number information operator 10₁, and a telephone number database 12₁. Using a telephone set 20₁, number information service user 2 receives a search result obtained by searching telephone number database 12₁, from telephone number information operator 10₁ through a telephone line network 3₁.

As such, in the conventional systems, by inputting a search condition to Web contents 10 or operator 10₁ (by selecting on the browser or through voice), database 12 is searched for the corresponding information, and the search result is either displayed on Web browser 20 or forwarded via voice announcement.

As compared with this, in case of IP telephony, assignment of telephone number is not based on an address (location) of the subscriber. Accordingly, in order to actualize provision of telephone number information in an IP telephony service, it is necessary to specify the location of a corporation or an individual who wants to provide telephone number information, etc.

For this reason, as shown in FIG. 3, an IP telephone subscriber 2 accesses a location registration content 10₂ of an ISP 1₂, and edits a location information database 12₂, so as to supply the own telephone number to the users of the telephone number information service. Thus, the location of IP telephone subscriber 2 can be specified.

When an IP telephone set is moved to a different place, IP telephone subscriber 2 again accesses location registration content 10₂ of ISP 1₂, and edits location information database 12₂ for subscriber 2. Thus, the system can easily provide the telephone number information of IP telephone subscriber 2 to the users who want to receive it.

However, IP telephony is serviced by a multiple of Internet Service Providers (ISPs) 1₂, each managing the telephone numbers on an ISP-by-ISP basis. This makes it very difficult to construct a system for the telephone number information service. Moreover, from the viewpoint of ISP 1₂, making good use of local features is requested.

### SUMMARY OF THE INVENTION

Accordingly, in consideration of the aforementioned IP telephony environment, it is an object of the present invention to provide an IP telephone number information system particularly having local features.

In order to attain the aforementioned object according to the present invention, as a first aspect, an IP telephone number information system includes a number information server connected through the Internet, and corporate information databases provided in a plurality of Internet Service Providers (ISPs). The number information server includes a region information database indicating IP telephony service areas provided by the plurality of ISPs. Each of the plurality of ISPs comprises a corporate information database, and the number information server specifies one of the plurality of ISPs from the region information database, based on a search condition input from a user terminal connected to the Internet. The specified ISP searches the corresponding corporate information database and obtains number information matching the search condition, and the number information server notifies to the user terminal the number information resulting from searching the corporate information database, in regard to the search condition input from the user terminal.

As a second aspect of the IP telephone number information system in accordance with the present invention to attain the aforementioned object, in the first aspect, the search condition to be input from the user terminal is input by accessing Web content of the number information server through a Web browser, and narrowing a search condition range properly is enabled on the Web browser.

As a third aspect of the IP telephone number information system to attain the aforementioned object, in the first aspect, the region information database stores information for specifying ISP in reference to an information pair constituted of region information and additional information. Also, the corporate information database stores an IP telephone number in reference to an information pair constituted of location information and additional information.

As a fourth aspect of the IP telephone number information system to attain the aforementioned object, in the first aspect, the number information server includes a cache memory for temporarily preserving the searched corporate information, and when the identical search condition is input afterward, the number information server searches the cache memory.

As a fifth aspect of the IP telephone number information system to attain the aforementioned object, in the fourth aspect, a management terminal connected to the number information server is provided. A supervisory time period is set from the management terminal, and the number information server deletes a preservation area in the cache memory at the set period.

Further scopes and features of the present invention will become more apparent by the following description of the embodiments with the accompanied drawings.

### BRIEF DESCRIPTION OF THE DRAWINGS

FIG. 1 shows a diagram illustrating a conventional system in which a user of telephone number information receives telephone number information through the Internet using a Web browser.

FIG. 2 shows a diagram illustrating a conventional system in which a user receives a telephone number information service from a telephone number information operator.

FIG. 3 shows a diagram illustrating a conventional system enabling providing a telephone number of the own office to a number information service user.

FIG. 4 shows a configuration diagram of an IP telephone number information system, according to an embodiment of the present invention.

FIG. 5 shows an explanation diagram illustrating operation for narrowing down a search range by inputting keyword selection on a Web browser from a number information service user shown in FIG. 4.

FIG. 6 shows a diagram illustrating an embodiment in which the user further expands the search range from the obtained search result output on the Web browser of the number information service user in step S5, in the embodiment shown in FIG. 4.

FIG. 7 shows a diagram illustrating an embodiment to improve search efficiency by use of a cache.

FIG. 8 shows a diagram illustrating a management method of a temporary preservation area 13 (cache memory) in a telephone number information server 1 in the embodiment shown in FIG. 7.

FIG. 9 shows an example for preventing temporarily preserved corporate information from becoming out of date, similar to the embodiment shown in FIG. 8.

FIG. 10 shows a diagram illustrating still another management method of a temporary preservation area of a cache memory, initiated from a management terminal.

FIG. 11 shows a diagram illustrating an example of a different management method of the cache memory for preventing preserved corporate information from becoming out of date.

FIG. 12 shows a diagram illustrating a second example of the different management method of cache memory for preventing preserved corporate information from becoming out of date.

FIG. 13 shows a diagram illustrating a third example of the different management method of cache memory for preventing preserved corporate information from becoming out of date.

FIG. 14 shows an exemplary configuration to improve search efficiency when searching region information and corporate information.

FIG. 15 shows an exemplary configuration to improve efficiency by grouping Internet Service Providers (ISPs) having corporate information.

FIG. 16 shows a diagram illustrating creation of region information.

FIG. 17 shows a diagram illustrating a process when corporate information is added.

FIG. 18 shows a diagram illustrating an example of automatically creating region information and storing the created information into a region information database.

FIG. 19 shows a diagram illustrating deletion and update of corporate information databases.

FIG. 20 shows a diagram illustrating deletion and update of region information by setting a supervisory time period.

FIG. 21 shows a diagram illustrating deletion and update of region information by a region information management means.

FIG. 22 shows a diagram illustrating a method of deleting and updating region information by timer setting.

FIG. 23 shows a diagram illustrating a method of deleting and updating region information by date and time setting.

FIG. 24 shows a diagram illustrating a method of deleting and updating region information corresponding to the case of no matched record found (NL) based on a search result.

FIG. 25 shows a diagram illustrating a method of deleting and updating region information by setting an access count.

FIG. 26 shows a diagram illustrating a method of deleting and updating region information by setting a supervisory time period.

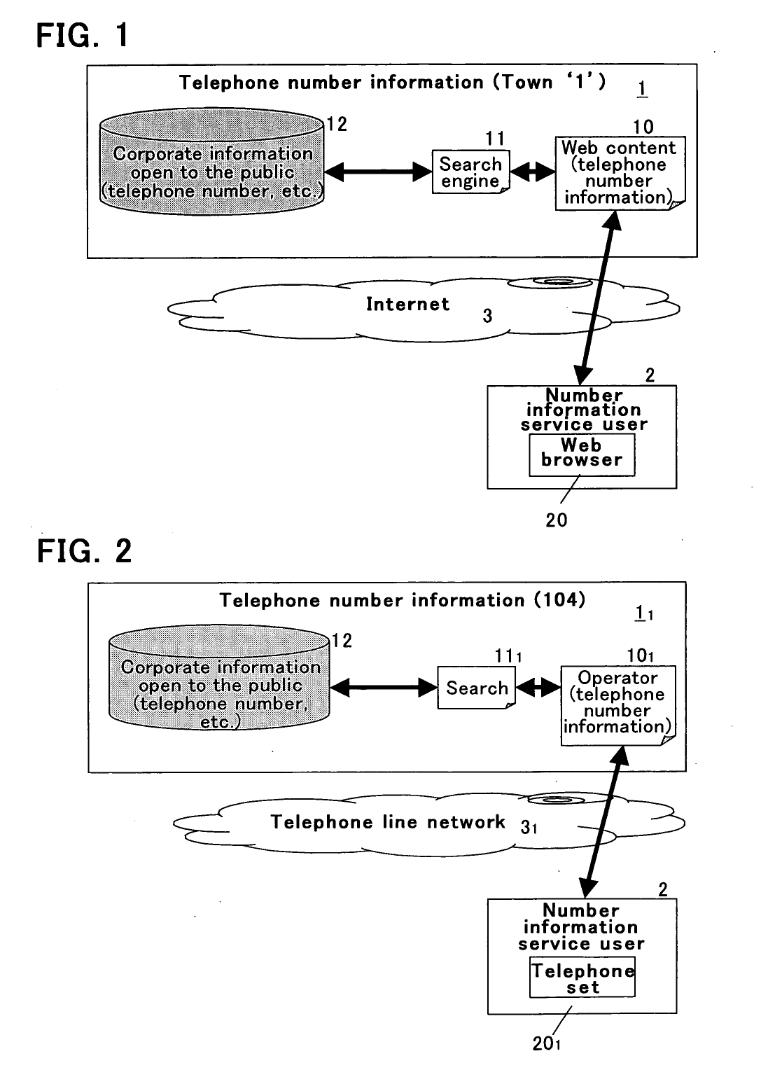

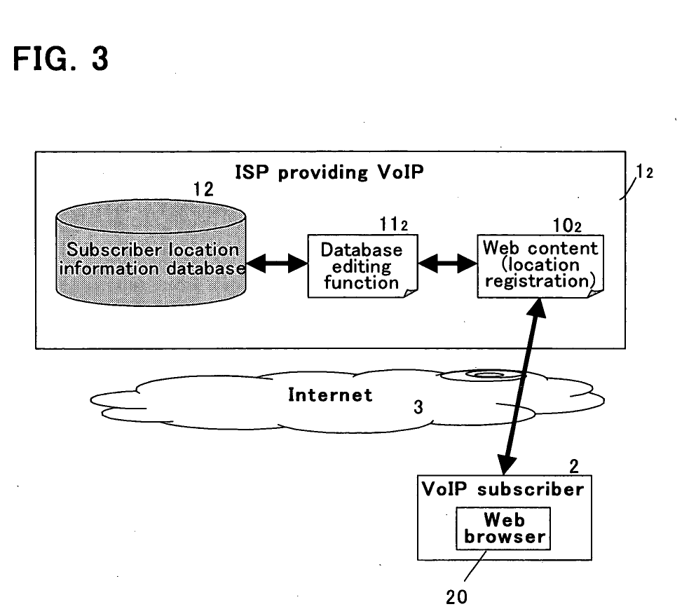

### DETAILED DESCRIPTION OF THE INVENTION

The preferred embodiment of the present invention is described hereinafter referring to the charts and drawings. However, it is noted that the scope of the present invention is not limited to the embodiments described below.

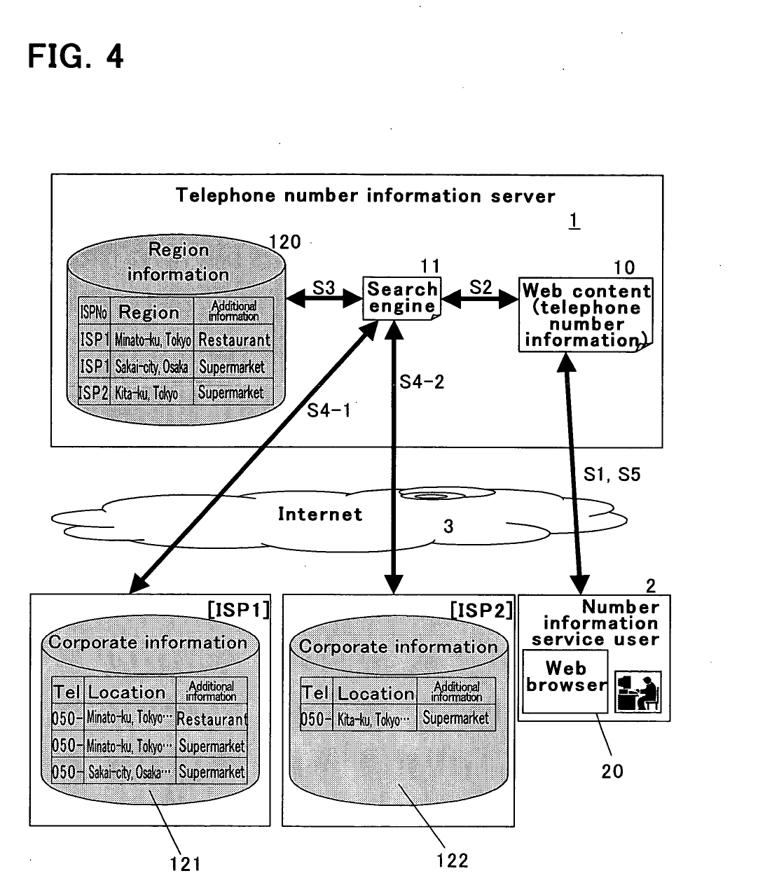

FIG. 4 shows a configuration diagram of an IP telephone number information system, according to an embodiment of the present invention. In FIG. 4, number information service user 2 accesses to Web content 10 provided in telephone number information server 1 using HTTP (Hypertext Transfer Protocol) (step S1), and input a search condition (step S1).

From Web content 10, the search condition input by number information service user 2 is fed to a search engine 11 (step S2).

Telephone number information server 1 has a region information database 120. This region information database 120 represents the relation of correspondence between the region of each ISP and additional information. Therefore, search engine 11 accesses region information database 120, and collects a record(s) in region information database 120 of which ‘region’ field matches the search condition, by which the Internet Service Provider(s) ISP1, ISP2 to be searched is specified.

Search engine 11 collects a record(s) of which ‘location’ field in corporate information database 121, 122 of the specified Internet Service Provider(s) ISP1, ISP2 to be searched matches a ‘region’ field in region information database 120, using SQL (Structure Query Language) (steps S4-1, S4-2).

Next, the collected corporate information is output to a Web browser 20 in number information service user 2 in the HTML (Hypertext Markup Language) format.

Here, as mentioned above, corporate information databases 121, 122 of the Internet Service Providers ISP1, ISP2 are searched for ‘location’ data, using ‘region’ information in region information database 120 as an index. However, as a modification, it may also be possible to perform the data search using the following method.

Namely, the following information is available as a search index key: address, station name, line name of electric train, postal code, telephone number, landmark (building, facilities), latitude and longitude, “Mapcode” (i.e. a location code in Japan developed by Denso Corp.), “Standard grid square code” (based on “Standard Grid Squares and Standard Grid Square Code used for the Statistics”, Announcement No. 143 by the then Administrative Management Agency of Japan on Jul. 12, 1973), road name, intersection name, interchange, bus stop, bus route, province, river, mountain, see, etc. The search may be performed using the above information individually, or in combination thereof.

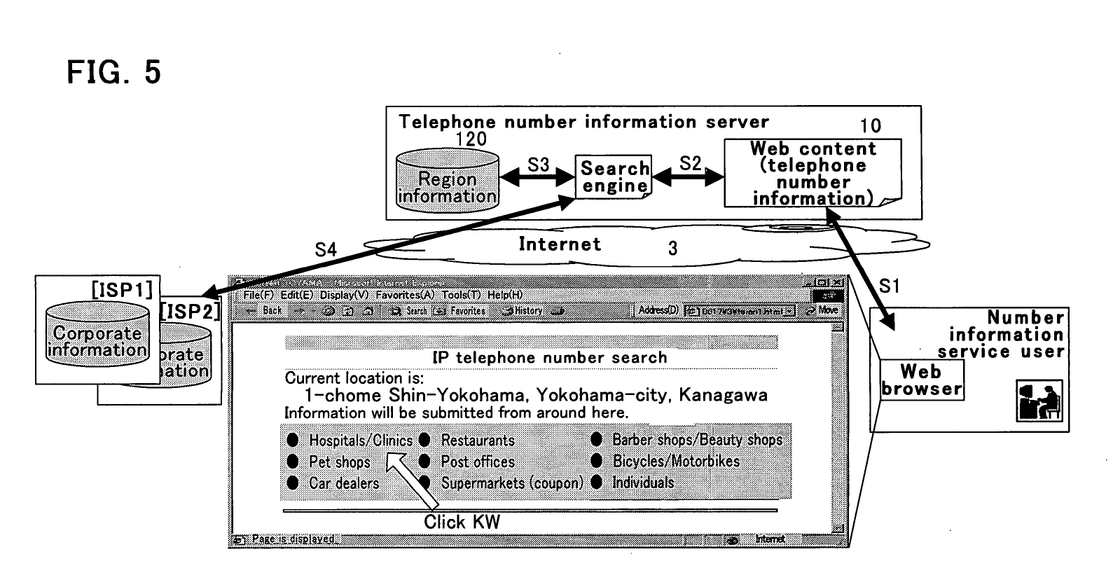

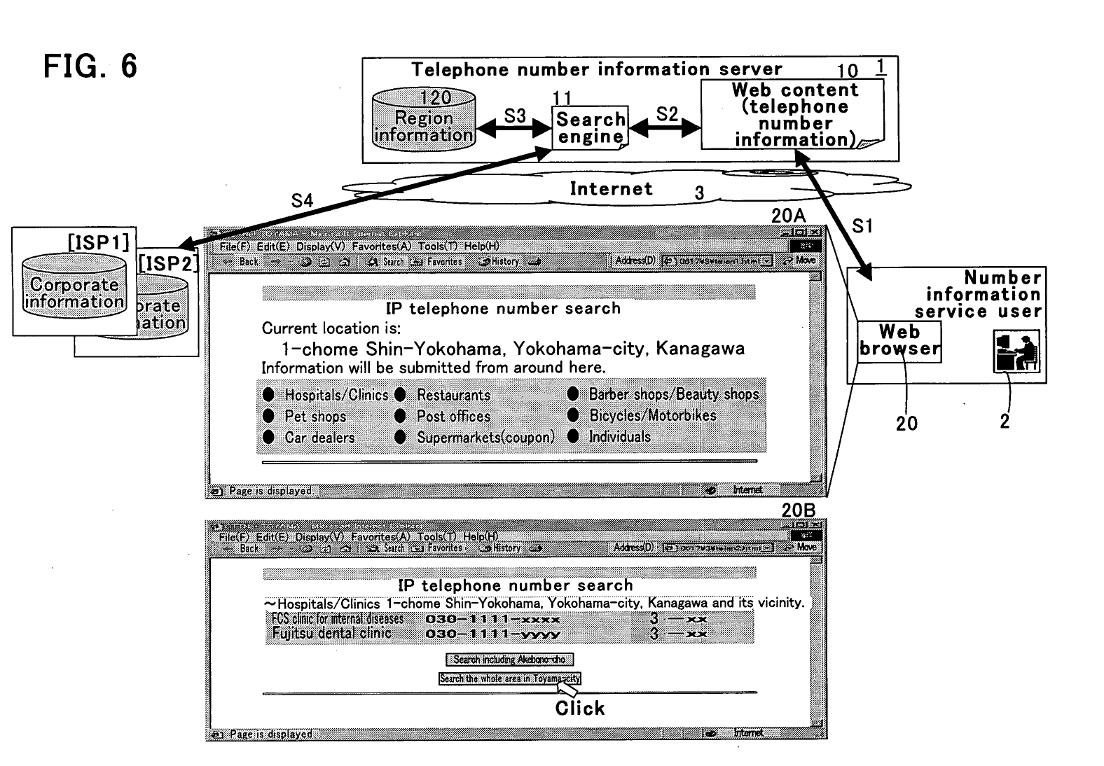

Further, as shown in FIG. 5, number information service user 2 can request to narrow down a search range by inputting selected keyword on Web browser 20. Or, number information service user 2 can request to expand the search range through the operation for expanding the region for search, as shown in FIG. 6.

In FIG. 5, number information service user 2 accesses Web content 10 provided in telephone number information server 1 using HTTP, and inputs a search condition (step S1). Further, number information service user 2 selects (clicks) a ‘keyword’ KW. (In FIG. 5, hospital/clinic is selected.) (step S1₁).

From Web content 10, the search condition and the keyword input by number information service user 2 are fed to search engine 11 (step S2).

Search engine 11 collects a record(s) of which ‘region’ field in region information database 120 matches the search condition, and at the same time ‘additional information’ field in the region information matches the keyword, and specifies the Internet Service Provider(s) ISP1, ISP to be searched (step S3).

Search engine 11 collects a record(s) of which ‘location’ field incorporate information database(s) 121, 122 of the Internet Service Provider(s) ISP1, ISP2 matches the ‘region’ field in region information database 120, and at the same time, ‘additional information’ field in corporate information databases 121, 122 matches the ‘additional information’ field in region information database 120 (step S4).

Search engine 11 then outputs the collected corporate information to Web browser 20 in number information service user 2, in the HTML format.

Here, as a modification of the ‘additional information’ for narrowing the search range, it is also possible to use business category, ISP, etc.

Also, in consideration of a case such that the search condition does not match data in region information database 120, by creating and deleting region information database 120 automatically, region information database 120 can be maintained up to date as will be described later.

FIG. 6 shows a diagram illustrating an embodiment in which the user further expands a search range from the obtained search result output on Web browser 20 of number information service user 2 in step S5, in the embodiment shown in FIG. 4.

Number information service user 2 expands, and inputs, the search condition using Web browser 20 (from 20A to 20B) (step S1). For example, number information service user 2 expands a search condition of the location address from “1-3 Minato-ku, Tokyo” to “Tokyo Metropolis”. Corresponding to this, the search condition is fed from Web content 10 to search engine 11 (step S2).

Next, search engine 11 collects a record(s) of which ‘region’ field in region information database 120 matches the search condition (step S3), and specifies the Internet Service Provider(s) ISP1, ISP2 to be searched. Then, using SQL, search engine 11 collects a record(s) of which ‘location’ field incorporate information database(s) 121, 122 of the Internet Service Provider(s) ISP1, ISP2 to be searched matches the ‘region’ field in region information database 120 (step S4). Search engine 11 then outputs the collected corporate information to Web browser 20 in number information service user 2, in the HTML format.

FIG. 7 shows a diagram illustrating an embodiment to improve search efficiency by use of a cache memory (or simply, a cache), as a feature of the present invention. In FIG. 7, number information service user 2 expands, and inputs, the search condition using Web browser 20 (step S1). For example, number information service user 2 expands a search condition of the location address from “1-3 Minato-ku, Tokyo” to “Tokyo Metropolis”. Corresponding to this, the search condition is fed from Web content 10 to search engine 11 (step S2).

Next, search engine 11 collects a record(s) of which ‘region’ field in region information database 120 matches the search condition (step S3), and specifies the Internet Service Provider(s) ISP1, ISP2 to be searched. Then, using SQL, search engine 11 collects a record(s) of which ‘location’ field incorporate information database(s) 121, 122 of the Internet Service Provider(s) ISP1, ISP2 to be searched matches the ‘region’ field in region information database 120 (steps S4-1, S4-2). Search engine 11 then outputs the collected corporate information to Web browser 20 in number information service user 2, in the HTML format (step S5).

Here, according to the embodiment shown in FIG. 7, ‘corporate information’ is also stored into a temporary preservation storage area 13. With this, it becomes possible to improve search efficiency when successive searches are performed in reference to the same search condition.

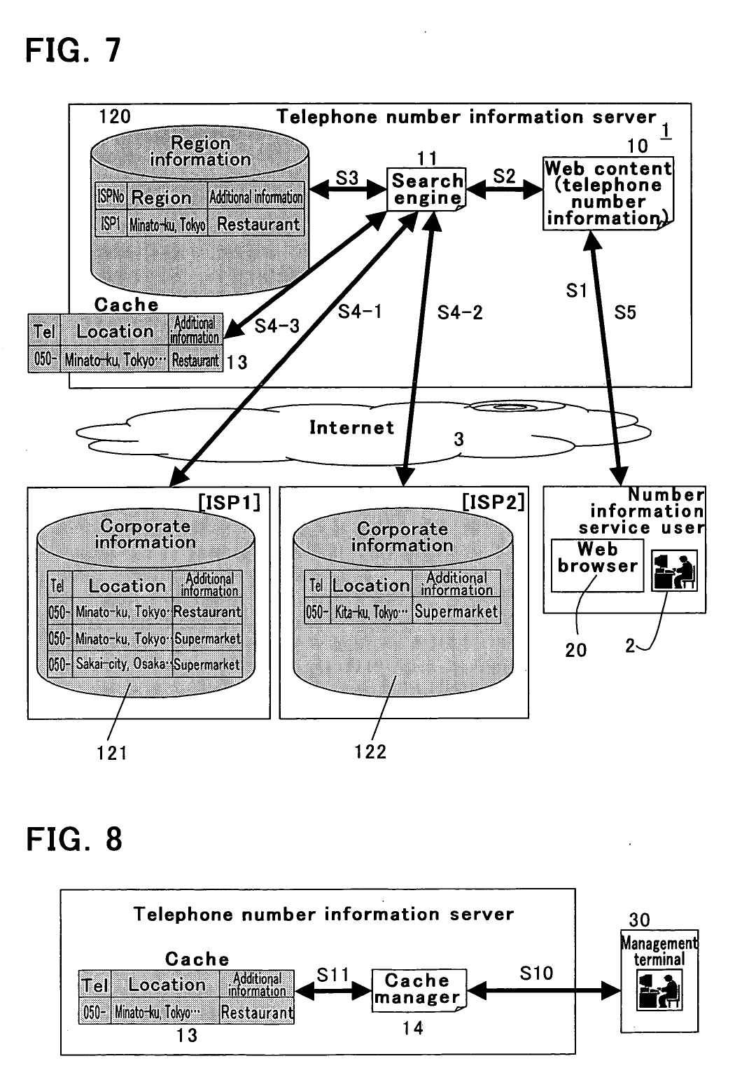

FIG. 8 shows a diagram illustrating a management method of temporary preservation area (cache memory) 13 in a telephone number information server 1, in the embodiment shown in FIG. 7. As shown in FIG. 8, a management terminal 30 is provided. From this management terminal 30, a supervisory time period for supervising the temporary preservation area is set into a cache manager 14 (step S10) At each supervisory time period being input and set from management terminal 30, cache manager 14 deletes the corporate information, which has temporarily been stored in cache memory 13, at the time period input from management terminal 30. With this function, it becomes possible to prevent the corporate information temporarily stored in cache memory 13 from becoming out of date.

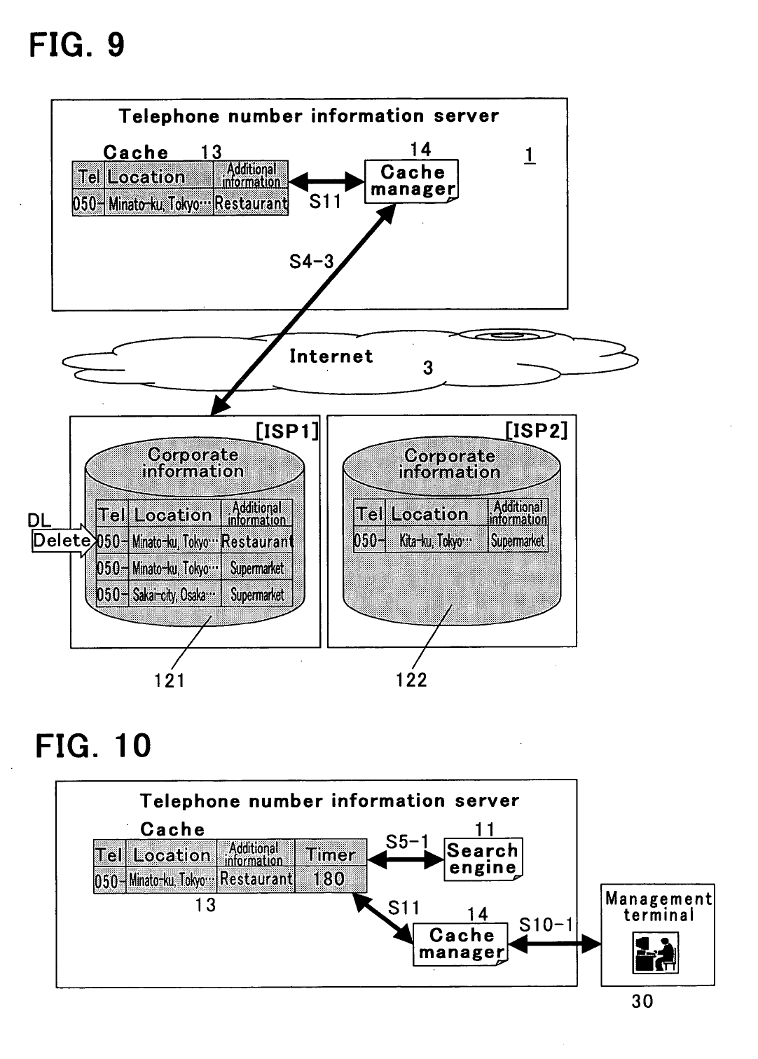

Similar to the embodiment shown in FIG. 8, FIG. 9 shows an example for preventing the temporarily preserved corporate information from becoming out of date. When the corporate information in corporate information database 121 managed by the Internet Service Provider ISP1 is deleted (DL), the deleted corporate information is transmitted to cache manager 14 in telephone number information server 1 (step S4-3). Cache manager 14 in telephone number information server 1 searches the temporary preservation area in cache memory 13, and if there is any data matching the received corporate information in the temporary preservation area, cache manager 14 deletes this data. With this function, it is possible to prevent the temporarily stored corporate information from becoming out of date.

FIG. 10 shows a diagram illustrating another management method of the temporary preservation area in cache memory 13, initiated from management terminal 30. When search engine 11 in telephone number information server 1 caches the corporate information into cache memory 13, search engine 11 sets a timer for the corporate information concerned (step S5-1).

The timer value set by search engine 11 and a supervisory time period for supervising the timeout of the timer to be measured are set in advance from management terminal 30 (step S10-1).

Cache manager 14 checks the timer value of the corporate information preserved in cache memory 13 at the period set in the step S10-1. If a timeout occurs, cache manager 14 deletes the corresponding corporate information (step S11-1). With this function, the temporarily preserved corporate information is prevented from becoming out of date.

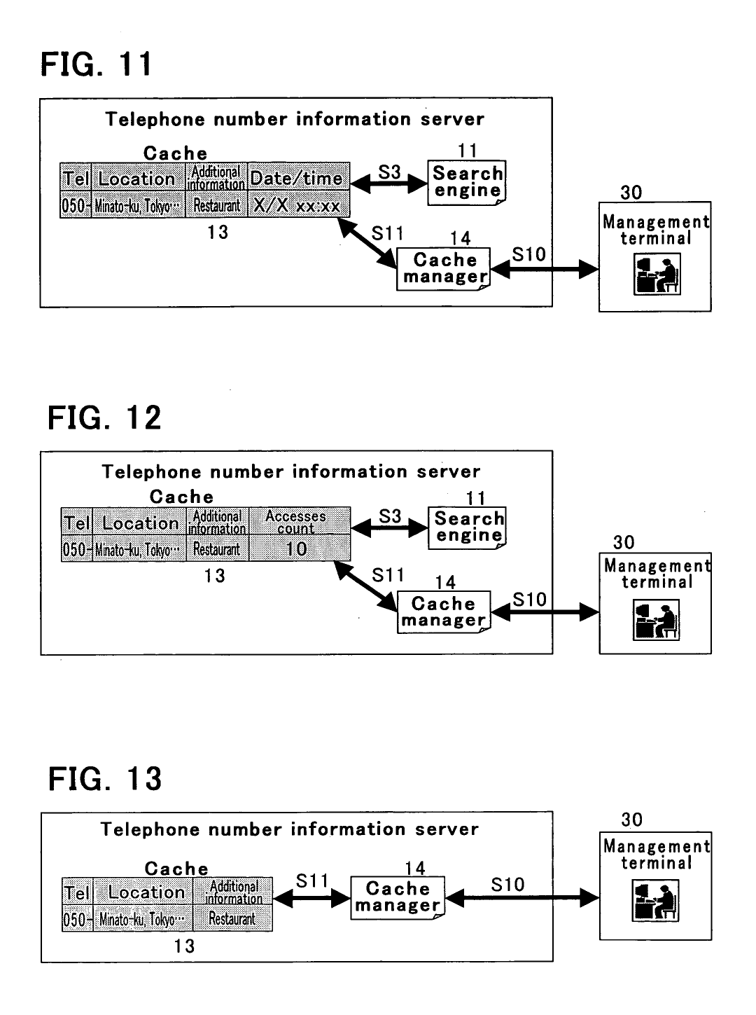

FIGS. 11 to 13 show diagrams respectively illustrating examples of other management methods for the cache memory to prevent the preserved corporate information from becoming out of date.

Referring to FIG. 11, when search engine 11 caches ‘corporate information’ into cache memory 13, search engine 11 sets the date and time of the corporate information being generated in the cache (step S51). Also, at the time of searching, search engine 11 checks cache memory 13, and updates the date and time if matched corporate information exists.

Here, both the lapse of time from the latest access date and time to delete the corporate information preserved in cache memory 13 and the time period for supervising the date and time are set in advance from management terminal 30 to cache manager 14 (step S10). Cache manager 14 checks the date and time of the corporate information preserved in cache memory 13 at the period having been set in the step S10-2, and if the lapse of time from the latest access date and time exceeds the preset value, cache manager 14 deletes the corresponding corporate information (step S11). With this function, the temporarily preserved corporate information is prevented from becoming out of date.

In FIG. 12, when search engine 11 caches the corporate information into cache memory 13, search engine 11 sets an access count for the corporate information concerned (step S11: In this embodiment, the access count is assumed to set to 10.)

Further, search engine 11 checks cache memory 13 at the time of searching. When matched corporate information is found, search engine 11 increments the access count. The time period for supervising the access count is set in advance from management terminal 30 (step S10). Cache manager 14 decrements the access count for the corporate information preserved in cache memory 13 at the period preset in the step S10.

If the access count becomes zero, cache manager 14 deletes the corresponding corporate information (step S11) With this function, the temporarily preserved corporate information is prevented from becoming out of date.

In the example shown in FIG. 13, the time period to be supervised and a condition for deletion are input from management terminal 30 (step S10). Cache manager 14 compares the corporate information preserved in cache memory 13 with the deletion condition (additional information or location information) at the period preset in the step S10. When the comparison results in a match, cache manager 14 deletes the corresponding corporate information (step S11). With this function, the temporarily preserved corporate information is prevented from becoming out of date.

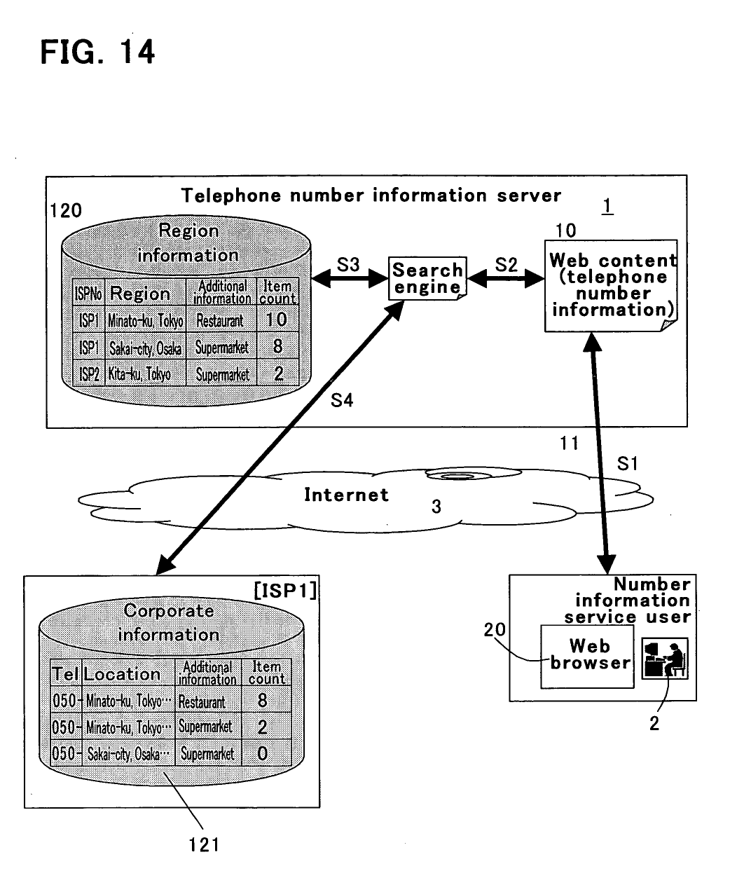

Now, FIG. 14 shows an exemplary configuration to improve search efficiency of searching ‘region information’ and ‘corporate information’.

In FIG. 14, number information service user 2 accesses Web content 10 provided in telephone number information server 1 using HTTP, and inputs a search condition (step S1).

The search condition input by number information service user 2 is fed from Web content 10 to search engine 11 (step S2). Search engine 11 searches region information database 120, and collects a record(s) of which ‘region’ field in region information database 120 matches the search condition, and specifies the Internet Service Provider(s) to be searched (step S3). At this time, search engine 11 increments the ‘count’ field in region information database 120, and compares the number with the number stored in the previous record. If the value in the ‘count’ field is larger than the value in the previous record, then search engine 11 replaces the record with the newly obtained record (step S4).

Then, using SQL, search engine 11 collects a record(s) of which ‘location’ field incorporate information database 121 of the Internet Service Provider ISP1 to be searched matches the ‘region’ field in region information database 120. At this time, search engine 11 increments the ‘count’ field in corporate information database 121, and compares the count value with the value stored in the previous record. If the value in the ‘count’ field is larger than the value in the previous record, then search engine 11 replaces the record with the newly obtained record (step S4).

Search engine 11 then outputs the collected corporate information to Web browser 20 in number information service user 2 in the HTML format. With this function, search efficiency of searching the region information and corporate information can be increased.

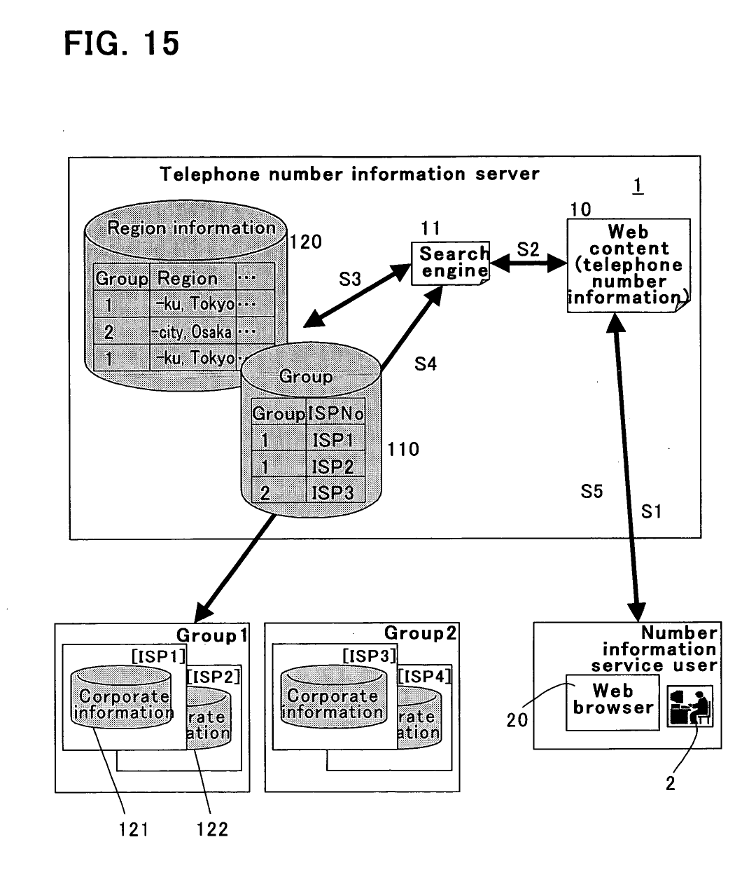

FIG. 15 shows an exemplary configuration to improve efficiency by grouping the Internet Service Providers (ISPs) based on the location in the corporate information.

In FIG. 15, number information service user 2 accesses Web content 10 provided in telephone number information server 1 using HTTP, and inputs a search condition (step S1).

The search condition input by number information service user 2 is fed from Web content 10 to search engine 11 (step S2).

Search engine 11 refers to region information database 120, and collects a record(s) of which ‘region’ field in the region information matches the search condition, and specifies the ISP group to be searched (step S3).

Using the specified group number, search engine 11 searches a group database 110, and specifies the Internet Service Provider(s) ISP1-ISP4 to be searched (step S4).

Then, using SQL, search engine 11 collects a record(s) of which ‘location’ field incorporate information database 121, 122 of the Internet Service Provider(s) to be searched matches the ‘region’ field in the region information (step S4). Search engine 11 then outputs the collected corporate information to Web browser 20 in number information service user 2 (step S5).

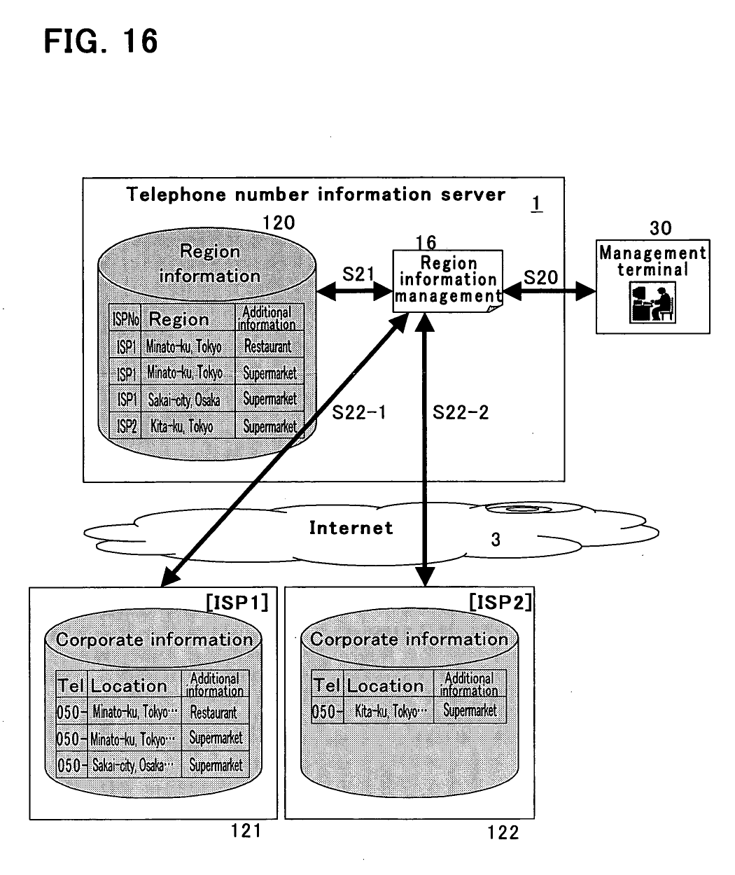

FIG. 16 shows a diagram illustrating creation of the region information. In FIG. 16, a time period is input from management terminal 30 (step S20), which is set to a region information manager 16. At the above period, each corporate information database 121, 122 of the Internet Service Provider ISP1, ISP2 is searched, and ‘region information’ is created. The created region information is stored into region information database 120.

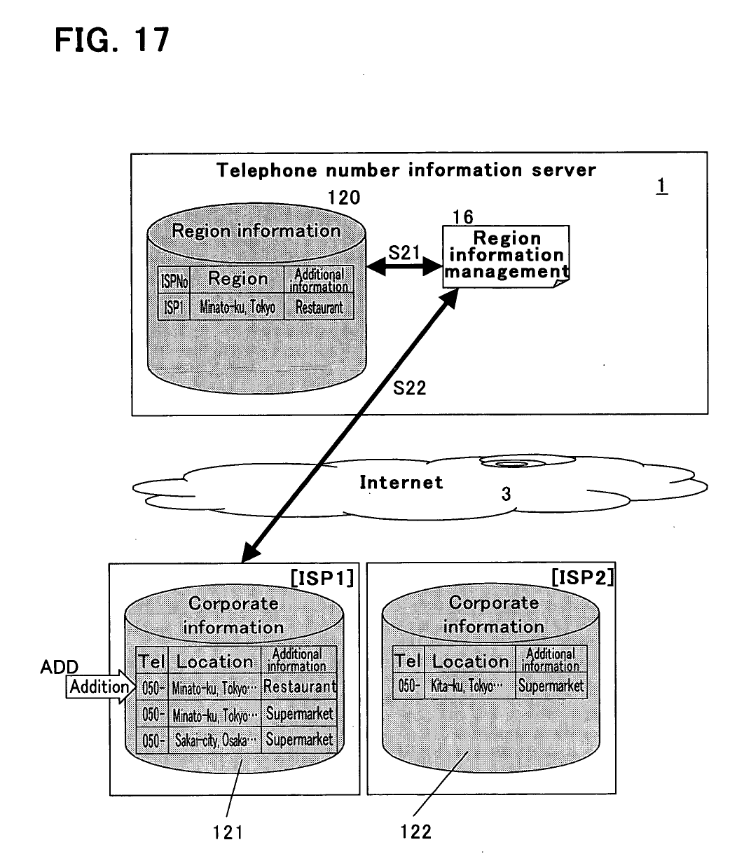

FIG. 17 shows a diagram illustrating a process when ‘corporate information’ is added. When the corporate information is added in each Internet Service Provider ISP1, ISP2, the added corporate information is transmitted to region information manager 16 provided in telephone number information server 1 (step S22). On receipt of this information, region information manager 16 creates region information database 120 based on the received corporate information.

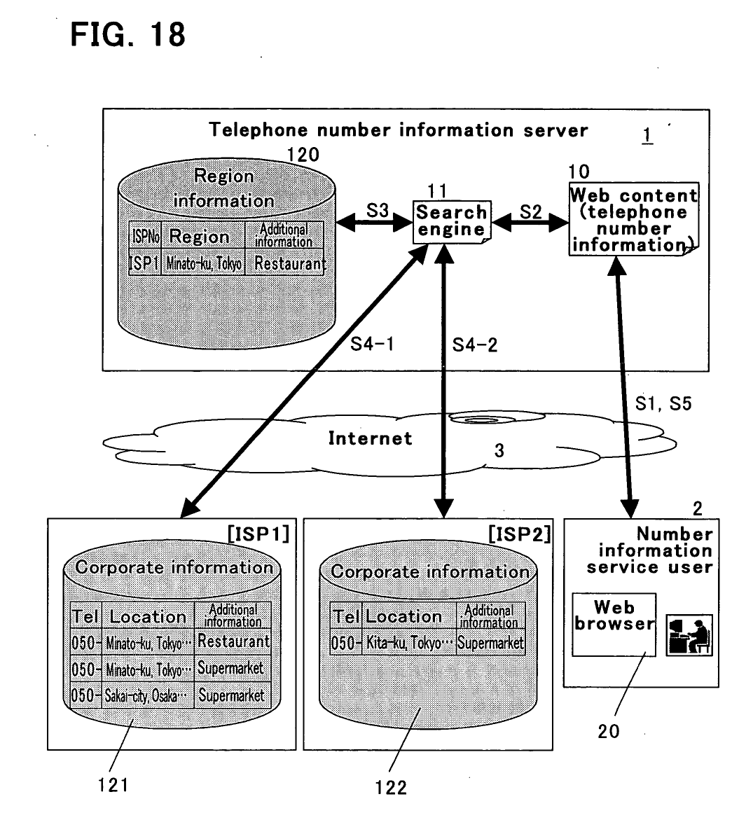

FIG. 18 shows a diagram illustrating an example of automatically creating ‘region information’ and storing the created information into region information database 120. In FIG. 18, number information service user 2 accesses Web content 10 provided in telephone number information server 1 using HTTP, and inputs a search condition (step S1). From Web content 10, the search condition is fed to search engine 11 (step S2).

Search engine 11 compares the ‘region’ field in region information database 120 with the search condition. As a result of this comparison, if no matched record is found, then search engine 11 compares the search condition with the ‘location’ field in corporate information database 121, 122 of each Internet Service Provider ISP1, ISP2, and checks whether any matched record exists. If there is a matched record(s), search engine 11 automatically creates the region information, and stores the created information into region information database 120.

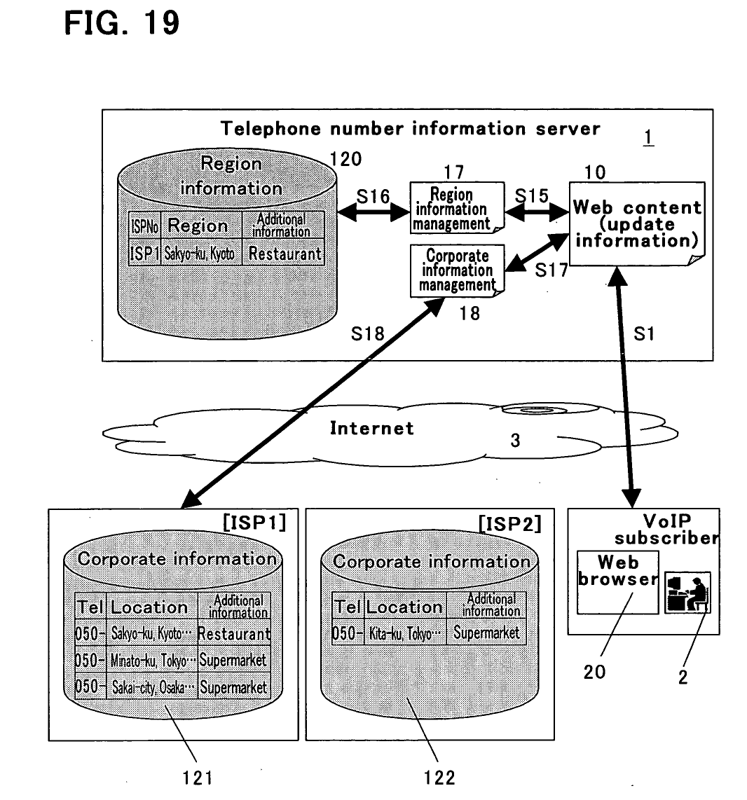

FIG. 19 shows a diagram illustrating update of corporate information databases 121, 122. In FIG. 19, a VoIP user2 accesses Web content 10 provided in telephone number information server 1 using HTTP (step S1), and then the input corporate information is fed from Web content 10 to region information manager 17 (step S15).

Region information manager 17 automatically creates the region information based on the corporate information. From Web content 10, the input corporate information is fed to a corporate information manager 18 (step S17). Corporate information manager 18 transmits the corporate information to the corresponding Internet Service Provider ISP1, ISP2. Each Internet Service Provider ISP1, ISP2 updates each corporate information database 121, 122.

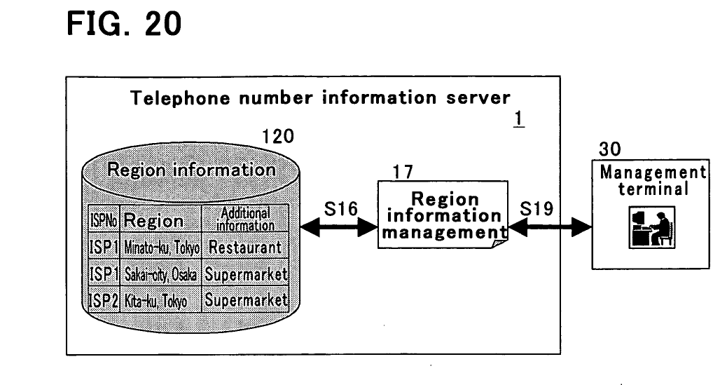

FIG. 20 shows a diagram illustrating update of region information database 120. In FIG. 20, a supervisory time period of region information database 120 is set from management terminal 30 to region information manager 17 (step S19). Region information manager 17 deletes the entire region information in region information database 120 at the period input from management terminal 30 (step S16). With this function, the region information is prevented from becoming out of date.

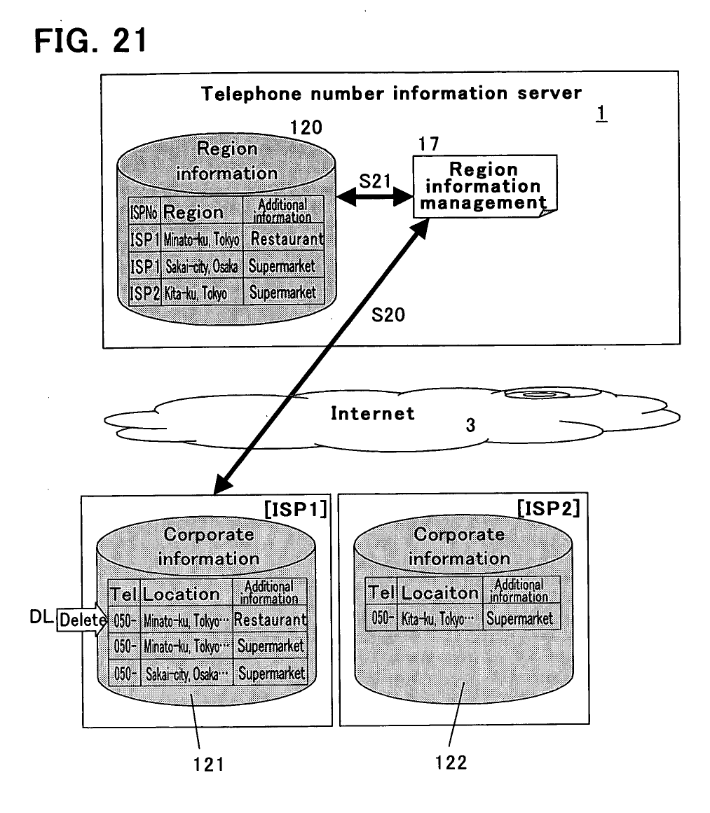

In FIG. 21, when the contents registered in corporate information database 121, 122 managed by the Internet Service Provider ISP1, ISP2 are deleted, the deleted corporate information is transmitted to region information manager 17 in telephone number information server 1. (step S20).

Region information manager 17 then deletes the region information matching the ‘region’ field of the received corporate information (step S21). With this function, the region information is prevented from becoming out of date.

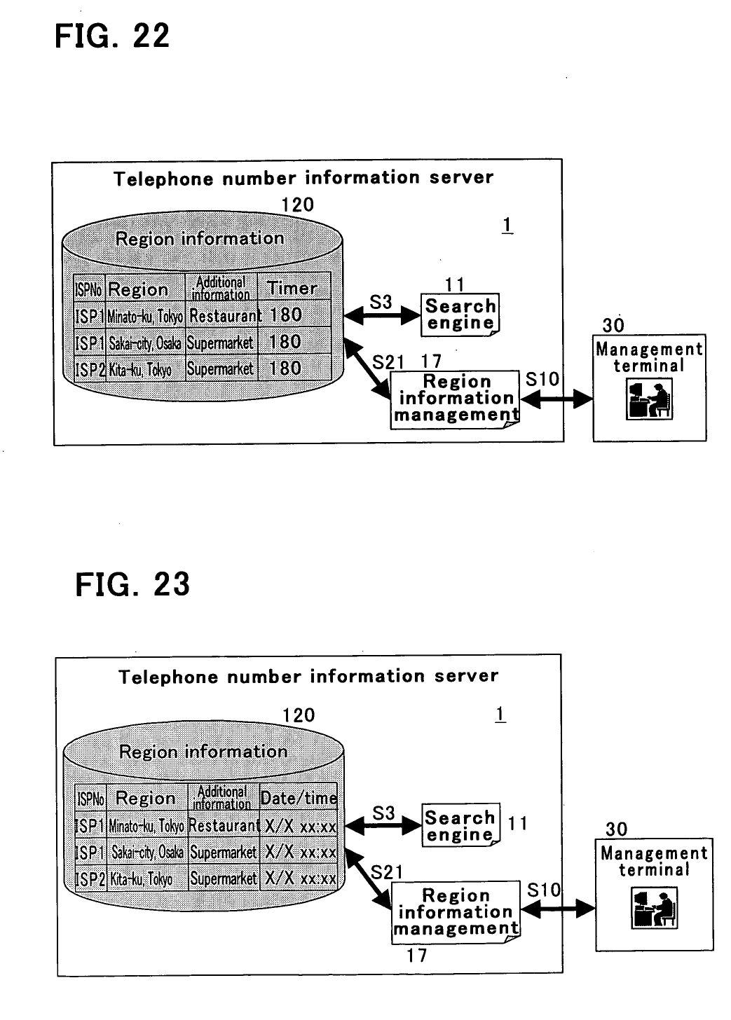

In FIG. 22, when search engine 11 creates the region information into region information database 120, search engine 11 sets a timer for the region information concerned. Both the timer value set by search engine 11 and the supervisory time period for supervising the occurrence of a timeout in the timer are set in advance from management terminal 30 (step S10).

Region information manager 17 checks the timer value of the region information at the preset period. On the occurrence of a timeout, region information manager 17 deletes the corresponding region information from region information database 120 (step S21). With this function, the region information is prevented from becoming out of date.

In FIG. 23, when search engine 11 creates the region information, the created date and time are set into the region information. Also, when the region information already exists, search engine 11 updates the date and time in the corporate information.

The lapse of time from the latest access date and time to the deletion of the region information, as well as the time period for supervising the date and time, is set in advance from management terminal 30. Region information manager 17 checks the date and time value in the region information at the preset period. When the lapse of time from the date and time of the latest access exceeds the preset value, region information manager 17 deletes the corresponding region information. With this function, the region information is prevented from becoming out of date.

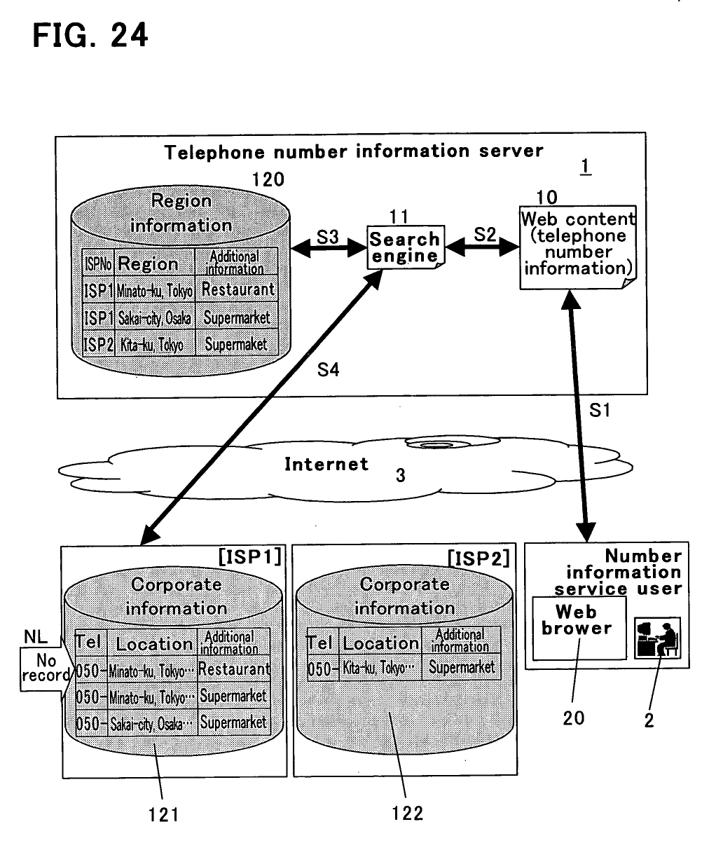

In FIG. 24, number information service user 2 accesses Web content 10 in the telephone number information server by use of HTTP, and inputs a search condition (step S1).

From Web content 10, the search condition is fed to search engine 11 (step S2). Search engine 11 collects a record(s) of which ‘region’ field in region information database 120 matches the search condition (step S3), and specifies the Internet Service Provider(s) ISP1, ISP2 to be searched. Next, using SQL, search engine 11 compares the ‘location’ field in corporate information database(s) 121, 122 of the Internet Service Provider(s) ISP1, ISP2 to be searched matches the ‘region’ field in region information database 120 (step S4). Based on the comparison result, search engine 11 deletes the region information in region information database 120 corresponding to the case of no matched record found (‘NL’). With this function, the region information is prevented from becoming out of date.

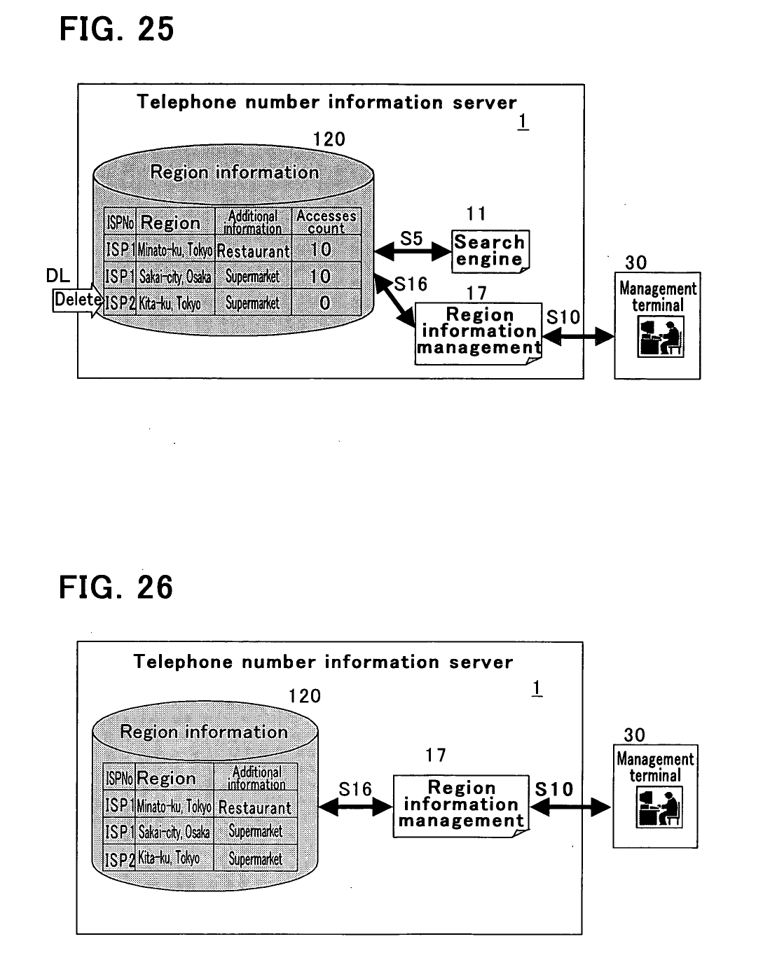

In FIG. 25, when search engine 11 creates the region information, search engine 11 sets the access count for the corporate information concerned. (In this embodiment, the access count is assumed to set to 10.) Further, search engine 11 increments the access count when the region information exists at the time of searching.

The time period for supervising the access count is set in advance from management terminal 30 (step S10). Region information manager 17 decrements the access count for the region information in region information database 120 at the period preset above. If the access count becomes zero, region information manager 17 deletes the corresponding region information. With this function, the region information is prevented from becoming out of date.

In FIG. 26, the time period to be supervised and a condition for deletion are input from management terminal 30 (step S10). Region information manager 17 compares the region information in region information database 120 with the deletion condition at the preset period. When the comparison results in a match, region information manager 17 deletes the corresponding region information. With this function, the region information is prevented from becoming out of date.

To summarize, according to the present invention, it becomes possible to provide an IP telephone number information service, like the telephone number information service provided for the existing communication system. With this, the users can receive excellent convenience in IP telephony, which will become more and more popularly used hereafter.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. An Internet Protocol (IP) telephone number information system comprising:
a number information server connected through the Internet; and
corporate information databases provided in a plurality of Internet Service Providers (ISPs),
wherein the number information server includes a region information database indicating IP telephony service areas provided by the plurality of ISPS, and
each of the plurality of ISPs has a corporate information database,
the number information server specifies one of the plurality of ISPs from the region information database, based on a search condition input from a user terminal connected to the Internet,
the specified ISP searches the corresponding corporate information database and obtains number information matching the search condition, and
the number information server notifies to the user terminal the number information resulting from searching the corporate information database, in regard to the search condition input from the user terminal.

2. The IP telephone number information system according to claim 1,
wherein the search condition to be input from the user terminal is input by accessing Web content of the number information server through a Web browser, and
narrowing down a search condition range properly is enabled on the Web browser.

3. The IP telephone number information system according to claim 1,
wherein the region information database stores information for specifying ISP in reference to an information pair constituted of region information and additional information, and
the corporate information database stores an IP telephone number in reference to an information pair constituted of location information and additional information.

4. The IP telephone number information system according to claim 1,
wherein the number information server includes a cache memory for temporarily preserving the searched corporate information, and
when the identical search condition is input afterward, the number information server searches the cache memory.

5. The IP telephone number information system according to claim 4, further comprising:
a management terminal connected to the number information server,
wherein a supervisory time period is set from the management terminal, and the number information server deletes a preservation area in the cache memory at the set period.

6. The IP telephone number information system according to claim 4,
wherein when the corporate information is deleted from the corporate information database corresponding to each ISP, the corresponding corporate information preserved in the cache memory is deleted.

7. The IP telephone number information system according to claim 4, further comprising:
a management terminal connected to the number information server,
wherein a time is set into a timer from the management terminal, and the number information server deletes the preservation area in the cache memory when the time set in the timer has elapsed.

8. The IP telephone number information system according to claim 4,
wherein when the cache memory is searched, a present time is recorded, and when the recorded present time is not updated for a predetermined time or more, the preservation area in the cache memory is deleted.

9. The IP telephone number information system according to claim 4,
wherein when the cache memory is searched, the access count is incremented by one, while when no search is performed for a predetermined time or more, the access count is decremented by one, and when the access count becomes a predetermined value or less, the preservation area in the cache memory is deleted.

10. The IP telephone number information system according to claim 5,
wherein a set condition is input from the management terminal, and in regard to the data matching the set condition, the number information server deletes the preservation area in the cache memory at the set period.

11. The IP telephone number information system according to claim 1, further comprising:
a grouped database in which the plurality of ISPs each corresponding to a regional unit of the region information database are grouped,
wherein a group corresponding to the input search condition is obtained, and one ISP is specified from the grouped database derived from the obtained group.

12. The IP telephone number information system according to claim 1, further comprising:
a management terminal connected to the number information server,
wherein a supervisory time period is set from the management terminal, and the number information server creates the region information database by referring to the corporate information database of the plurality of ISPs at the set period.

13. The IP telephone number information system according to claim 1,
wherein the number information server includes a region information management means, and
the region information management means supervises addition of corporate information to the corporate information databases of the plurality of ISPs, and creates the region information database when the corporate information is added.

14. The IP telephone number information system according to claim 1,
wherein the number information server searches the region information database based on the input search condition, and when no region information matching the input search condition is found, the number information server causes the plurality of ISPs to search a location field of the corporate information database in the ISP concerned using the search condition, while when a matched record is found, the region information is created by the ISP concerned.

15. The IP telephone number information system according to claim 1,
wherein the number information server creates region information based on a modification of the corporate information input from an IP telephone subscriber.

16. The IP telephone number information system according to claim 1, further comprising:
a management terminal connected to the number information server,
wherein a supervisory time period is set from the management terminal, and the number information server deletes region information in the region information database at the set period.

17. The IP telephone number information system according to claim 1,
wherein when the corporate information databases of the plurality of ISPs are deleted, the number information server deletes the corresponding region information from the region information database.

18. The IP telephone number information system according to claim 12,
wherein when creating the region information, the number information server sets a timer corresponding to the region information, and triggered by the expiration of the timer, the number information server deletes the corresponding region information.

19. The IP telephone number information system according to claim 12,
wherein when creating the region information, the number information server sets a present date and time corresponding to the region information, and when the identical search condition is input next time and after, the present date and time are updated, and when update is not performed for a predetermined period after the present date and time are set, the number information server deletes the region information.

20. The IP telephone number information system according to claim 1,
wherein the number information server searches the region information database according to the input search condition, and when no data matching the searched region information is found in the corporate information database, the number information server deletes the region information from the region information database.

21. The IP telephone number information system according to claim 1,
wherein the number information server increments the access count by one when searching the region information database, and decrements the access count by one when no search is performed for a predetermined time period, and when the access count becomes a predetermined value or less, the number information server deletes the corresponding region information in the region information database.

22. The IP telephone number information system according to claim 1, further comprising:
a management terminal connected to the number information server,
wherein a predetermined condition is set from the management terminal, and the number information server supervises periodically, and deletes a data matching the predetermined condition from the region information database.
